(19) United States
(12) Patent Application Publication
(10) Pub. No.: US 2024/0405708 A1
(43) Pub. Date: Dec. 5, 2024

(54) SWITCHOVER ASYMMETRIC H-BRIDGE CIRCUIT FOR SERIES AND PARALLEL MODE OPERATION OF SRM MOTOR

(71) Applicant: CHARA TECHNOLOGIES PVT LTD, Bengaluru (IN)

(72) Inventors: Bhaktha Ram Keshavachar, Bengaluru (IN); Mahalingam Koushik Balasubramanian, Bengaluru (IN)

(21) Appl. No.: 18/699,203

(22) PCT Filed: Oct. 5, 2022
(86) PCT No.: PCT/IN2022/050887

§ 371 Date: Apr. 5, 2024

(30) Foreign Application Priority Data
Oct. 4, 2021 (IN) 202141045014

(51) Int. Cl. H02P 25/086; H02P 25/092

(52) U.S. Cl. CPC H02P 25/086; H02P 25/092

(57) ABSTRACT

The embodiments herein disclose a switchover asymmetric H-Bridge circuit for series and parallel mode operation of a switched reluctance motor (SRM) motor. In an embodiment, the proposed switchover asymmetric H-Bridge circuit is used to achieve higher inductance and torque at lower speeds and lower winding inductance to reach higher speeds of operation. In an embodiment, an asymmetric H-Bridge topology that has been modified to support series-parallel switch-over by using only two extra devices (MOSFET switches). Further, the ability to switch between higher inductance/torque production and lower inductance/high speed operation.

### CROSS-REFERENCE TO RELATED APPLICATIONS

This application is a national stage application of the Patent Cooperation Treaty (PCT) international stage application titled “SWITCHOVER ASYMMETRIC H-BRIDGE CIRCUIT FOR SERIES AND PARALLEL MODE OPERATION OF SRM MOTOR”, numbered PCT/IN2022/050887, filed at World Intellectual Property Organization (WIPO) on Oct. 5, 2022. The aforementioned PCT international phase application claims priority from the Indian Utility Provisional Patent Application (PPA) with Ser. No. 202141045014 filed on 4 Oct. 2021 with the title “SWITCHOVER ASYMMETRIC H-BRIDGE CIRCUIT FOR SERIES AND PARALLEL MODE OPERATION OF SRM MOTOR”. The contents of the abovementioned Provisional Patent Application and Pct Application are included in entirety as reference herein.

### BACKGROUND

### Technical Field

The embodiments herein generally relate to the field of electrical motors. The embodiments herein are particularly related to switched reluctance motors. The embodiments herein are more particularly related to a switchover asymmetric H-bridge circuit for series and parallel mode operation of a switched reluctance motor (SRM) motor.

In general, an asymmetric H-bridge circuit is a common topology used to drive Switched Reluctance Motors (SRMs). The switched reluctance motors depend on reluctance forces caused by changing inductance of the motor windings with the rotor position. In order to produce sufficient torque, a high inductance value is needed. However, the rate of increase of current in the winding is inversely proportional to the inductance of the winding. Hence, it is difficult to achieve higher currents at higher speeds when the time duration available for increasing and decreasing the current during turn-on/off for each phase is limited. Thus, the maximum torque and speed achievable in the SRM is limited by this constraint. This prevents us from meeting higher power output and torque requirements.

In another existing method, a single winding with an asymmetric H-bridge (AHB) will either not provide the required torque or be able to achieve high speed operation. Further, other drive topologies will need more switches and/or diodes to achieve the switchover functionality. FIG. 1 illustrates a circuit diagram in the prior art, which employs a greater number of switches to create a series and parallel mode of operation. FIG. 1 illustrates that, the number of switches needed to create a series and parallel configuration is eight (Q1, Q2, Q3, Q4, Q5, Q6, Q7 and Q8). In addition, the asymmetric H-Bridge Switches Q1 and Q4 in FIG. 1, requires to be rated for twice the current rating to support the parallel mode operation. Hence, this increases the overall cost and size needed for the drive circuitry.

Thus, it is desired to address the above-mentioned disadvantages or other shortcomings or at least provide a useful alternative. Hence, there is a long-felt need for an improved asymmetric H-Bridge circuit and method for achieving higher inductance and torque at lower speeds and lower winding inductance to reach higher speeds of operation in SRM motor.

The above-mentioned shortcomings, disadvantages and problems are addressed herein, and which will be understood by reading and studying the following specification.

The primary object of the embodiments herein is to provide a switchover asymmetric H-Bridge circuit for series and parallel mode operation of a SRM motor.

Another object of the embodiments herein is to achieve higher inductance and torque at lower speeds and lower winding inductance to reach higher speeds of operation.

Yet another object of the embodiments herein is to provide an asymmetric H-Bridge topology that has been modified to support series-parallel switch-over by using only two extra devices (e.g., metal-oxide semiconductor field-effect transistor (MOSFET) switches). Further, the ability to switch between higher inductance/torque production and lower inductance/high speed operation.

These and other objects and advantages of the present invention will become readily apparent from the following detailed description taken in conjunction with the accompanying drawings.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments of the present invention provide a switchover asymmetric H-bridge circuit for series and parallel mode operation of a SRM motor.

According to an embodiment herein, a motor winding and drive mechanism is provided. The windings of each phase are divided into two segments of equal turns. Each segment is controlled individually by an asymmetric H-Bridge circuit. In addition, a cross-over switch is connected between an end of one segment and a start of the next segment, to perform both series and parallel modes of operation for each phase.

According to an embodiment herein, the switch-over MOSFETs (Q5 & Q6) are turned ON for a series mode of operation. The high-side metal-oxide-semiconductor field-effect transistor (MOSFET) connected to a segment-1 (Q1) and a low-side MOSFET connected to a segment-2 (Q4) are used to drive current into the winding. A low-side MOSFET of a segment-1 (Q2) and a high-side MOSFET of the segment-2 (Q3) are disabled. This H-bridge circuit connects the two segments of the winding in an effective series mode. The effective inductance of the winding is twice the inductance of each segment.

According to an embodiment herein, the switch-over MOSFETs (Q5 & Q6) are turned OFF for a parallel mode of operation. The high-side and low-side MOSFETs of both H-Bridge (Q1-Q3, Q2-Q4) are driven with synchronized ON/OFF signals. The current set-point for each segment is kept at half the commanded current and the total current for both segments together meets the commanded current. This H-bridge circuit is used to connect both segments of the winding in an effective parallel mode. The effective inductance of each winding is half the inductance of each segment.

According to an embodiment herein, the switchover asymmetric H-Bridge circuit is used to achieve higher inductance and torque at lower speeds and lower winding inductance to reach higher speeds of operation.

According to an embodiment herein, an asymmetric H-Bridge is modified to support series-parallel switch-over by using only two extra devices (e.g., MOSFET switches). Further, the asymmetric H-Bridge is modified to switch between higher inductance/torque production and lower inductance/high speed operation.

According to an embodiment herein, two or three windings in the series mode/the parallel mode are provided in the switchover asymmetric H-Bridge circuit to achieve a wider range of inductance variation.

According to an embodiment herein, the switchover asymmetric H-bridge circuit is provided with other switches instead of MOSFET's based on need/requirement (for both phase switches and changeover switches).

According to an embodiment herein, the H-bridge circuit comprises a plurality of winding sections, wherein the number of winding sections is selected/chosen based on user requirement.

The embodiments herein provide a switchover asymmetric H-Bridge circuit for series and parallel mode operation of a SRM motor. According to an embodiment herein, the switchover asymmetric H-Bridge circuit is used to achieve higher inductance and torque at lower speeds and lower winding inductance to reach higher speeds of operation. According to an embodiment herein, an asymmetric H-Bridge circuit is modified to support series-parallel switch-over by using only two extra devices (e.g., MOSFET switches). Further, the asymmetric H-Bridge circuit is also used to achieve the switch-over between higher inductance/torque production and lower inductance/high speed operation.

According to one embodiment herein, a switchover asymmetric H-Bridge circuit for operation of a switched reluctance motor (SRM) is provided. The switchover asymmetric H-Bridge circuit comprises a plurality of windings arranged on each phase of a switched reluctance motor (SRM) motor. The plurality of windings of each phase of the SRM motor further comprises a plurality of sub-windings or segments of equal turns. Each of the plurality of sub-windings is controlled individually by an asymmetric H-Bridge circuit. The asymmetric H-Bridge circuit comprises a plurality of switches configured with a plurality of diodes. The asymmetric H-Bridge circuit, comprising each of the plurality of sub-windings, is connected to each other through a plurality of cross-over switches. The connection between the asymmetric H-Bridge circuit, configuring the plurality of sub-windings with the plurality of cross-over switches is established by connecting an end of one segment of the plurality of sub-windings and a start of the next segment of the plurality of sub-windings. Furthermore, the connection between the plurality of sub-windings through the plurality of cross-over switches provides an option to perform both series and parallel mode of operation for each phase of the SRM to vary the inductance and torque or speed performance. Moreover, each of the series-parallel combination of the plurality of sub-windings with the plurality of cross-over switches is considered as a gear setting. The gear setting with the plurality of sub-windings in series is considered as a lower gear, and the gear setting with the plurality of sub-windings in parallel is considered as a higher gear.

According to one embodiment herein, the asymmetric H-Bridge circuit with the plurality of cross-over switches is used to achieve higher inductance and torque at lower speeds, and lower inductance and torque at higher speeds of operation. The plurality of cross-over switches used in the asymmetric H-Bridge circuit includes two cross-over switches. Besides, the plurality of cross-over switches is used as bi-directional blocking devices and slow switching devices. The use of the plurality of cross-over switches as bi-directional blocking devices, is achieved by using two cross-over switches in opposite directions.

According to one embodiment herein, the plurality of cross-over switches includes MOSFETs, SCR, Thyristor or Solid-state relays. Thus, the switchover asymmetric H-bridge circuit is provided with other switches instead of MOSFET's based on need/requirement (for both phase switches and changeover switches). Furthermore, the plurality of phase switches in the asymmetric H-Bridge circuit includes MOSFETs, Power BJTs, IGBTs, SiC MOSFETs or GaN MOSFETs. Furthermore, the plurality of diodes is used in the asymmetric H-Bridge circuit to conduct current in one direction.

According to one embodiment herein, the plurality of sub-windings connected through the plurality of cross-over switches in series mode, helps to achieve higher effective inductance or torque at lower speeds. The effective inductance of the plurality of windings is twice the inductance of each of the plurality of sub-windings. Similarly, the plurality of sub-windings connected through the plurality of cross-over switches in parallel mode, helps to achieve lower effective inductance or torque at higher speeds. Furthermore, the effective inductance of the plurality of windings is half the inductance of each of the plurality of sub-windings. In addition, the the H-bridge circuit comprises a plurality of winding sections, wherein the number of winding sections is selected/chosen based on user requirement. Subsequently, the number of pluralities of sub-windings connected in series or parallel are increased by using additional asymmetric H-Bridge circuits and the plurality of cross-switches.

According to one embodiment herein, the asymmetric H-Bridge circuit with the plurality of cross-over switches is configured to connect the plurality of sub-windings in the series or parallel mode to achieve a wider range of inductance variation. In addition, the circuit, and the motor are designed to achieve both higher inductance/torque at lower speeds and lower inductance to enable high speed operation. Furthermore, the asymmetric H-Bridge circuit is modified to support series-parallel switch-over by using only two extra devices (e.g., MOSFET switches), and to provide a switch-over between higher inductance/torque production and lower inductance/high speed operation.

According to one embodiment herein, a method for operation of a switched reluctance motor (SRM) using switchover asymmetric H-Bridge circuit is provided. The method comprises configuring a plurality of windings on each phase of a SRM motor. The plurality of windings of each phase of the SRM comprises of a plurality of sub-windings or segments of equal turns. The each of the plurality of sub-windings is controlled individually by an asymmetric H-Bridge circuit. Subsequently, the asymmetric H-Bridge circuit is configured with a plurality of switches and a plurality of diodes. By connecting the asymmetric H-Bridge circuit, each of the plurality of sub-windings is configured through a plurality of cross-over switches. The connection between the asymmetric H-Bridge circuit, configured with plurality of sub-windings through the plurality of cross-over switches is established by connecting an end of one segment of the plurality of sub-windings and a start of the next segment of the plurality of sub-windings. Finally, the method includes performing both series and parallel mode of operation for each phase of the SRM to vary the inductance and torque or speed performance. Furthermore, the each of the series-parallel combination of the plurality of sub-windings with the plurality of cross-over switches is considered as a gear setting. The gear setting with the plurality of sub-windings in series is considered as a lower gear and the gear setting with the plurality of sub-windings in parallel is considered as a higher gear. Therefore, the different gear settings are switched mutually to achieve the application demands of the SRM motor in an optimal manner.

According to one embodiment herein, the method for achieving required inductance or torque is provided. The method comprises measuring current torque and speed, and estimating a commanded torque. Further, evaluating and continuing to function normally, when the commanded torque and speed is within the capability of current inductance. The method further includes increasing inductance by determining whether the commanded torque level is above maximum torque at current speed level, and the current speed level is below a maximum speed limit at next higher gear. Furthermore, reducing inductance by determining whether the current speed level is above the maximum speed limit at the current torque level, and the commanded torque level is below the maximum torque level at next lower gear.

According to one embodiment herein, the plurality of sub-windings connected through the plurality of cross-over switches in series mode, helps to achieve higher effective inductance or torque at lower speeds. The effective inductance of the plurality of windings in series mode is twice the inductance of each of the plurality of sub-windings. Similarly, the plurality of sub-windings connected through the plurality of cross-over switches in parallel mode, helps to achieve lower effective inductance or torque at higher speeds and the effective inductance of the plurality of windings in parallel mode is half the inductance of each of the plurality of sub-windings. Therefore, the asymmetric H-Bridge circuit with the plurality of cross-over switches is configured to connect the plurality of sub-windings in the series or parallel mode to achieve a wider range of inductance variation.

According to one embodiment herein, the asymmetric H-Bridge circuit supporting series and parallel mode of operation for each phase of SRM, is achieved by using two extra cross-over switches. The plurality of cross-over switches is used as bi-directional blocking devices and slow switching devices. Furthermore, the use of the plurality of cross-over switches as bi-directional blocking devices is achieved by using two cross-over switches in opposite directions. Furthermore, the plurality of cross-over switches includes MOSFETs, SCR, Thyristor or Solid-state relays and the plurality of switches in the asymmetric H-Bridge circuit includes MOSFETs, Power BJTs, IGBTs, SiC MOSFETs or GaN MOSFETs. In addition, the plurality of diodes is used in the asymmetric H-Bridge circuit to conduct current in one direction.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a circuit diagram in prior art, which employs a greater number of switches to create a series and parallel mode of operation.

FIG. 2 illustrates a circuit diagram of a switchover asymmetric H-Bridge circuit for series and parallel mode of operation of a SRM motor, according to an embodiment herein.

FIG. 2A illustrates the current flow in a switchover asymmetric H-Bridge circuit, during series mode of operation of SRM motor, according to an embodiment herein.

FIG. 2B illustrates the current flow in a switchover asymmetric H-Bridge circuit, during parallel mode of operation of SRM motor, according to an embodiment herein.

FIG. 3 illustrates a circuit diagram of switchover asymmetric H-Bridge circuit, with more than two sub-windings in the series and parallel mode of operation of a SRM motor, according to an embodiment herein.

FIG. 3A illustrates the current flow in a switchover asymmetric H-Bridge circuit, during series mode of operation of SRM motor, according to an embodiment herein.

FIG. 3B illustrates the current flow in a switchover asymmetric H-Bridge circuit, during parallel mode of operation of SRM motor, according to an embodiment herein.

FIG. 4 illustrates the two sub-windings connected in series and parallel mode, according to an embodiment herein.

FIG. 5 illustrates a flowchart of a method for operation of a switched reluctance motor (SRM) using switchover asymmetric H-Bridge circuit, according to an embodiment herein.

FIG. 6 illustrates a flowchart of a method for achieving required inductance or torque, according to an embodiment herein.

FIG. 7 illustrates a flowchart for a method of switching between different combinations to achieve required inductance or torque, according to an embodiment herein.

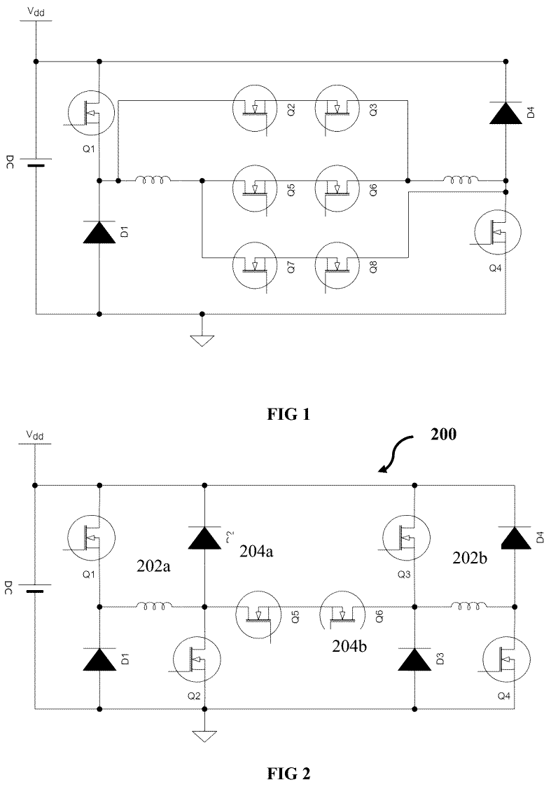

### DETAILED DESCRIPTION

Although the specific features of the embodiments herein are shown in some drawings and not in others. This is done for convenience only as each feature may be combined with any or all the other features in accordance with the embodiments herein.

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a switchover asymmetric H-Bridge circuit for series and parallel mode operation of a SRM motor. In an embodiment, the proposed switchover asymmetric H-Bridge circuit is used to achieve higher inductance and torque at lower speeds and lower winding inductance to reach higher speeds of operation. In an embodiment, an asymmetric H-Bridge topology that has been modified to support series-parallel switch-over by using only two extra devices (e.g., MOSFET switches). Further, the ability to switch between higher inductance/torque production and lower inductance/high speed operation.

According to one embodiment herein, a switchover asymmetric H-Bridge circuit for operation of a switched reluctance motor (SRM) is provided. The switchover asymmetric H-Bridge circuit comprises a plurality of windings arranged on each phase of a switched reluctance motor (SRM) motor. The plurality of windings of each phase of the SRM motor further comprises a plurality of sub-windings or segments of equal turns. Furthermore, each of the plurality of sub-windings is controlled individually by an asymmetric H-Bridge circuit. The asymmetric H-Bridge circuit comprises a plurality of switches configured with a plurality of diodes. In addition, the asymmetric H-Bridge circuit, configuring each of the plurality of sub-windings is connected to each other through a plurality of cross-over switches. The connection between the asymmetric H-Bridge circuit, configuring the plurality of sub-windings with the plurality of cross-over switches is established by connecting an end of one segment of the plurality of sub-windings and a start of the next segment of the plurality of sub-windings. Furthermore, the connection between the plurality of sub-windings through the plurality of cross-over switches provides an option to perform both series and parallel mode of operation for each phase of the SRM to vary the inductance and torque or speed performance. Moreover, each of the series-parallel combination of the plurality of sub-windings with the plurality of cross-over switches is considered as a gear setting. The gear setting with the plurality of sub-windings in series is considered as a lower gear, and the gear setting with the plurality of sub-windings in parallel is considered as a higher gear.

According to one embodiment herein, the asymmetric H-Bridge circuit with the plurality of cross-over switches is used to achieve higher inductance and torque at lower speeds, and lower inductance and torque at higher speeds of operation. The plurality of cross-over switches used in the asymmetric H-Bridge circuit includes two cross-over switches. Besides, the plurality of cross-over switches is used as bi-directional blocking devices and slow switching devices. The use of the plurality of cross-over switches as bi-directional blocking devices, is achieved by using two cross-over switches in opposite directions.

According to one embodiment herein, the plurality of cross-over switches includes MOSFETs, SCR, Thyristor or Solid-state relays. Thus, the switchover asymmetric H-bridge circuit is provided with other switches instead of MOSFET's based on need/requirement (for both phase switches and changeover switches). Furthermore, the plurality of switches in the asymmetric H-Bridge circuit includes MOSFETs, Power BJTs, IGBTs, SiC MOSFETs or GaN MOSFETs. Furthermore, the plurality of diodes is used in the asymmetric H-Bridge circuit to conduct current in one direction.

According to one embodiment herein, the plurality of sub-windings connected through the plurality of cross-over switches in series mode, helps to achieve higher effective inductance or torque at lower speeds. The effective inductance of the plurality of windings is twice the inductance of each of the plurality of sub-windings. Similarly, the plurality of sub-windings connected through the plurality of cross-over switches in parallel mode, helps to achieve lower effective inductance or torque at higher speeds. Furthermore, the effective inductance of the plurality of windings is half the inductance of each of the plurality of sub-windings. In addition, the the H-bridge circuit comprises a plurality of winding sections, wherein the number of winding sections is selected/chosen based on user requirement. Subsequently, the number of pluralities of sub-windings connected in series or parallel are increased by using additional asymmetric H-Bridge circuits and the plurality of cross-switches.

According to one embodiment herein, the asymmetric H-Bridge circuit with the plurality of cross-over switches is configured to connect the plurality of sub-windings in the series or parallel mode to achieve a wider range of inductance variation. In addition, the circuit, and the motor are designed to achieve both higher inductance/torque at lower speeds and lower inductance to enable high speed operation. Furthermore, the asymmetric H-Bridge topology has been modified to support series-parallel switch-over by using only two extra devices (e.g., MOSFET switches). The ability to switch between higher inductance/torque production and lower inductance/high speed operation.

According to one embodiment herein, a method for operation of a switched reluctance motor (SRM) using switchover asymmetric H-Bridge circuit is provided. The method comprises configuring a plurality of windings on each phase of a SRM motor. The plurality of windings of each phase of the SRM comprises of a plurality of sub-windings or segments of equal turns. The method further includes controlling individually each of the plurality of sub-windings by an asymmetric H-Bridge circuit. Subsequently, configuring the asymmetric H-Bridge circuit with a plurality of switches and a plurality of diodes. Furthermore, the method includes connecting the asymmetric H-Bridge circuit, configuring each of the plurality of sub-windings through a plurality of cross-over switches. The connection between the asymmetric H-Bridge circuit, configuring plurality of sub-windings through the plurality of cross-over switches is established by connecting an end of one segment of the plurality of sub-windings and a start of the next segment of the plurality of sub-windings. Finally, the method includes performing both series and parallel mode of operation for each phase of the SRM to vary the inductance and torque or speed performance. Furthermore, the each of the series-parallel combination of the plurality of sub-windings with the plurality of cross-over switches is considered as a gear setting. The gear setting with the plurality of sub-windings in series is considered as a lower gear and the gear setting with the plurality of sub-windings in parallel is considered as a higher gear. Therefore, the different gear settings are switched mutually to achieve the application demands of the SRM motor in an optimal manner.

According to one embodiment herein, the method for achieving required inductance or torque is provided. The method comprises measuring current torque and speed, and estimating a commanded torque. Further, evaluating and continuing to function normally, when the commanded torque and speed is within the capability of current inductance. The method further includes increasing inductance by determining whether the commanded torque level is above maximum torque at current speed level, and the current speed level is below a maximum speed limit at next higher gear. Furthermore, reducing inductance by determining whether the current speed level is above the maximum speed limit at the current torque level, and the commanded torque level is below the maximum torque level at next lower gear.

According to one embodiment herein, the plurality of sub-windings connected through the plurality of cross-over switches in series mode, helps to achieve higher effective inductance or torque at lower speeds. The effective inductance of the plurality of windings in series mode is twice the inductance of each of the plurality of sub-windings. Similarly, the plurality of sub-windings connected through the plurality of cross-over switches in parallel mode, helps to achieve lower effective inductance or torque at higher speeds and the effective inductance of the plurality of windings in parallel mode is half the inductance of each of the plurality of sub-windings. Therefore, the asymmetric H-Bridge circuit with the plurality of cross-over switches is configured to connect the plurality of sub-windings in the series or parallel mode to achieve a wider range of inductance variation.

According to one embodiment herein, the asymmetric H-Bridge circuit supporting series and parallel mode of operation for each phase of SRM, is achieved by using two extra cross-over switches. The plurality of cross-over switches is used as bi-directional blocking devices and slow switching devices. Furthermore, the use of the plurality of cross-over switches as bi-directional blocking devices is achieved by using two cross-over switches in opposite directions. Furthermore, the plurality of cross-over switches includes MOSFETs, SCR, Thyristor or Solid-state relays and the plurality of switches in the asymmetric H-Bridge circuit includes MOSFETs, Power BJTs, IGBTs, SiC MOSFETs or GaN MOSFETs. In addition, the plurality of diodes is used in the asymmetric H-Bridge circuit to conduct current in one direction.

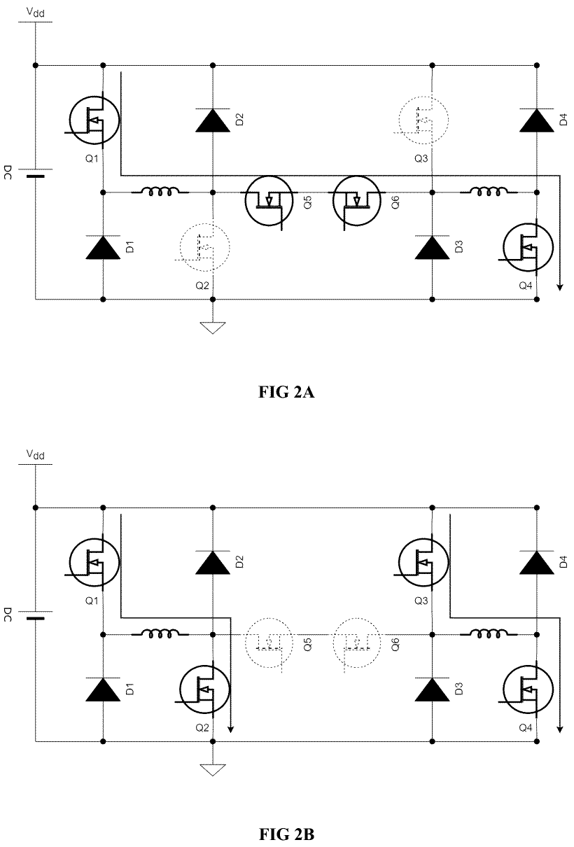

According to one embodiment herein, FIG. 2 illustrates a circuit diagram of a switchover asymmetric H-Bridge circuit for series and parallel mode of operation of a SRM motor, according to an embodiment herein. The FIG. 2 200, illustrates a circuit diagram of a switchover asymmetric H-bridge circuit for series and parallel mode operation of a SRM motor. As shown in the FIG. 2, 200 a new motor winding and drive topology has been proposed. The plurality of windings of each phase are divided into the plurality of sub-windings or segments of equal turns. The FIG. 2, 200 shows two segments 202a and 202b of equal turns. Each segment is controlled individually by an asymmetric H-Bridge circuit. In addition, two cross-over switches 204a and 204b is connected between an end of one segment and a start of the next segment. Hence, the circuit provides an option to perform both series and parallel modes of operation for each phase.

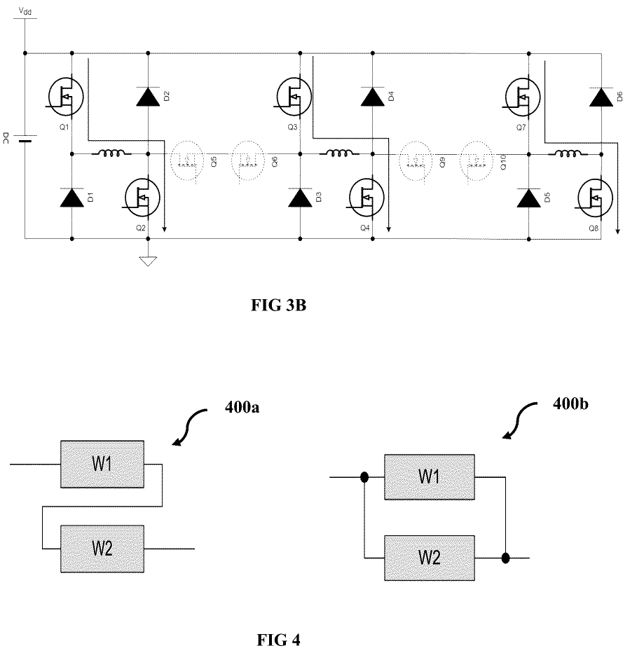

According to one embodiment herein, FIG. 4 illustrates the two sub-windings connected in series and parallel mode. FIG. 4, 400a illustrates two sub-windings connected in series and 400b illustrates the two sub-windings connected in parallel.

According to one embodiment herein, FIG. 2A illustrates the current flow in a switchover asymmetric H-Bridge circuit, during series mode of operation of SRM motor. In series mode of operation, the switch-over MOSFETs (Q5 & Q6) are turned ON. A high-side MOSFET connected to a segment-1 (Q1) and a low-side MOSFET connected to a segment-2 (Q4) are used to drive current into the winding. A low-side MOSFET of a segment-1 (Q2) and a high-side MOSFET of a segment-2 (Q3) are disabled. This topology connects the two segments of the winding in an effective series mode. The effective inductance of the winding is twice the inductance of each segment.

According to one embodiment herein, FIG. 2B illustrates the current flow in a switchover asymmetric H-Bridge circuit, during parallel mode of operation of SRM motor. In parallel mode of operation, the switch-over MOSFETs (Q5 & Q6) are turned OFF. The high-side and low-side MOSFETs of both H-Bridge (Q1-Q3, Q2-Q4) are driven with synchronized ON/OFF signals. The current set-point for each segment is kept at half the commanded current and the total current for both segments together meets the commanded current. This topology can be used to connect both segments of the winding in an effective parallel mode. The effective inductance of each winding is half the inductance of each segment.

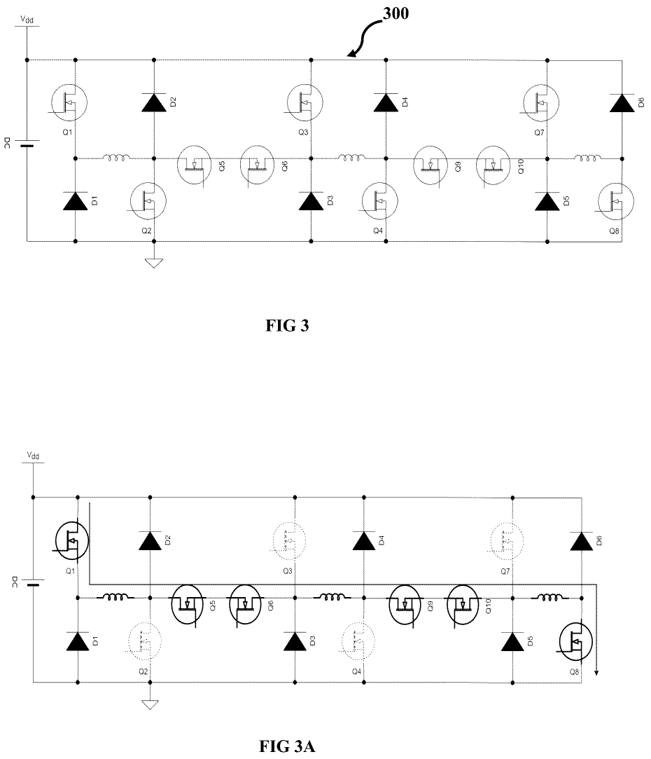

According to one embodiment herein, FIG. 3 illustrates a circuit diagram of switchover asymmetric H-Bridge circuit, with more than two sub-windings in the series and parallel mode of operation of a SRM motor. In order to connect more than two windings in series and parallel configuration, additional asymmetric H-Bridge stages and cross-over switches are used. With respect to the FIG. 3, 300 shows the circuit, with three sub-windings, connected in series and parallel mode.

According to one embodiment herein, FIG. 3A illustrates the current flow in a switchover asymmetric H-Bridge circuit, during series mode of operation of SRM motor. FIG. 3A illustrates the series mode of operation, in which the switches Q1, Q5, Q6, Q9, Q10 and Q8 are turned on. Switches Q2, Q3, Q4 and Q7 are disabled.

According to one embodiment herein, FIG. 3B illustrates the current flow in a switchover asymmetric H-Bridge circuit, during parallel mode of operation of SRM motor. FIG. 3B illustrates the parallel mode of operation, in which the switches Q1, Q2, Q3, Q4, Q7 and Q8 are turned on. Switches Q5, Q6, Q9 and Q10 are disabled.

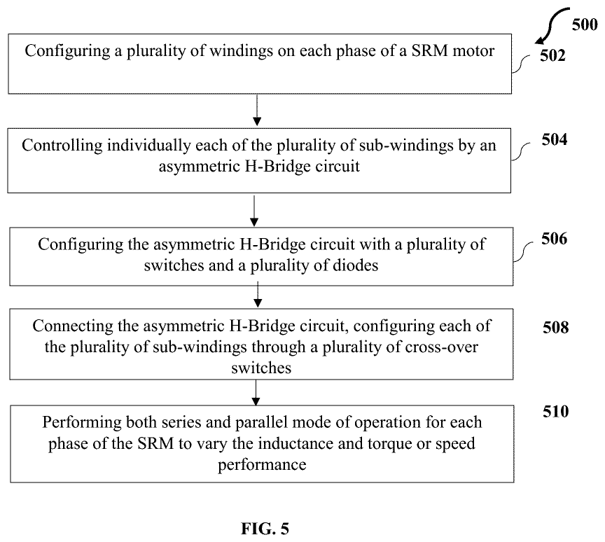

According to one embodiment herein, the FIG. 5 illustrates a flowchart of a method for operation of a switched reluctance motor (SRM) using switchover asymmetric H-Bridge circuit. The method 500 comprises configuring a plurality of windings on each phase of a SRM motor at step 502. The plurality of windings of each phase of the SRM comprises of a plurality of sub-windings or segments of equal turns. The method 500 further includes controlling individually each of the plurality of sub-windings by an asymmetric H-Bridge circuit at step 504. Subsequently, at step 506, configuring the asymmetric H-Bridge circuit with a plurality of switches and a plurality of diodes. Furthermore, the method 500 includes connecting the asymmetric H-Bridge circuit, configuring each of the plurality of sub-windings through a plurality of cross-over switches at step 508. The connection between the asymmetric H-Bridge circuit, configuring plurality of sub-windings through the plurality of cross-over switches is established by connecting an end of one segment of the plurality of sub-windings and a start of the next segment of the plurality of sub-windings. Finally, the method 500 includes performing both series and parallel mode of operation for each phase of the SRM to vary the inductance and torque or speed performance at step 510. Furthermore, the each of the series-parallel combination of the plurality of sub-windings with the plurality of cross-over switches is considered as a gear setting. The gear setting with the plurality of sub-windings in series is considered as a lower gear and the gear setting with the plurality of sub-windings in parallel is considered as a higher gear. Therefore, the different gear settings are switched mutually to achieve the application demands of the SRM motor in an optimal manner.

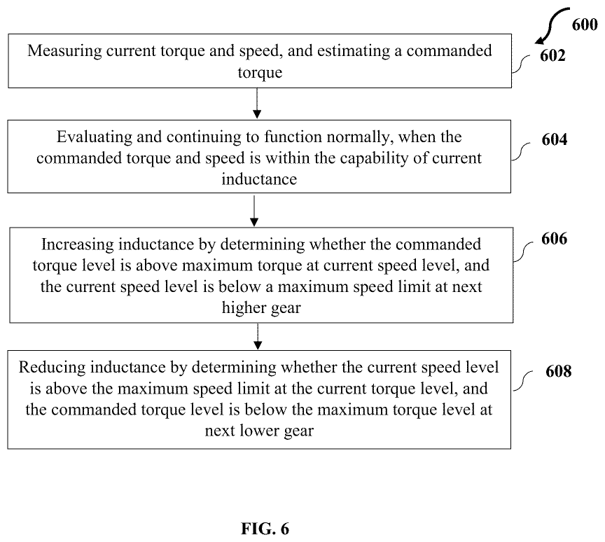

According to one embodiment herein, the FIG. 6 illustrates a flowchart of a method for achieving required inductance or torque. The method 600 comprises measuring current torque and speed, and estimating a commanded torque at step 602. Further, at step 604 evaluating and continuing to function normally, when the commanded torque and speed is within the capability of current inductance. The method 600 further includes increasing inductance after determining that the commanded torque level is above maximum torque at current speed level, and the current speed level is below a maximum speed limit at next higher gear at step 606. Furthermore, the method 600 includes reducing inductance after determining/judging that the current speed level is above the maximum speed limit at the current torque level and the commanded torque level is below the maximum torque level at next lower gear at step 608.

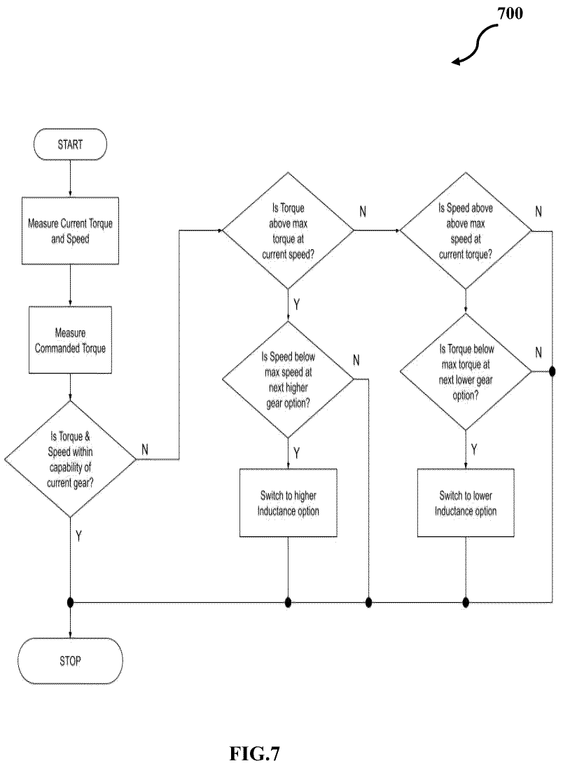

FIG. 7 illustrates a detailed flowchart on method for switching between different combinations to achieve required inductance or torque. The method 700 illustrates a detailed flowchart on method to switch to higher inductance and torque at lower speed. Subsequently, switching to lower inductance and torque at higher speed.

Although the embodiments herein are described with various specific embodiments, it will be obvious for a person skilled in the art to practice the embodiments herein with modifications.

The switchover asymmetric H-Bridge circuit for series and parallel mode operation of a switched reluctance motor (SRM) motor disclosed in the embodiments herein have several exceptional advantages. The circuit and motor design, to achieve both higher inductance/torque at lower speeds and lower inductance to enable high speed operation is provided. The asymmetric H-Bridge topology has been modified to support series-parallel switch-over by using only two extra devices (e.g., MOSFET switches). The ability to switch between higher inductance/torque production and lower inductance/high speed operation.

Also, the main advantage of the embodiments herein is the reduction in the number of switches used to achieve series and parallel configuration of the sub-windings. Furthermore, the number of MOSFETs needed to realize the series-parallel operation is six, when compared to prior art is eight, which decreases the overall cost and size needed for the drive circuitry. In addition, the asymmetric H-Bridge MOSFETs share the current during parallel mode of operation, hence reducing the current rating and thermal requirements. Therefore, by reducing the number of switches to realize the series and parallel configurations, the overall system cost is reduced and, optimizes the performance.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

We claim:

1. A switchover asymmetric H-Bridge circuit (200) for operation of a switched reluctance motor (SRM) comprising:
a plurality of windings arranged on each phase of a switched reluctance motor (SRM) motor; and wherein the plurality of windings of each phase of the SRM motor comprises of a plurality of sub-windings or segments of equal turns; and wherein each of the plurality of sub-windings is controlled individually by an asymmetric H-Bridge circuit;
wherein the asymmetric H-Bridge circuit comprises a plurality of switches configured with a plurality of diodes; and wherein the asymmetric H-Bridge circuit, configuring each of the plurality of sub-windings is connected to each other through a plurality of cross-over switches; and wherein the connection between the asymmetric H-Bridge circuit, configuring the plurality of sub-windings with the plurality of cross-over switches is established by connecting an end of one segment of the plurality of sub-windings and a start of the next segment of the plurality of sub-windings; and wherein the connection between the plurality of sub-windings through the plurality of cross-over switches provides an option to perform both series and parallel mode of operation for each phase of the SRM to vary the inductance and torque or speed performance; and wherein the each of the series-parallel combination of the plurality of sub-windings with the plurality of cross-over switches is considered as a gear setting, and wherein the gear setting with the plurality of sub-windings in series is considered as a lower gear and the gear setting with the plurality of sub-windings in parallel is considered as a higher gear.

2. The system (200) according to claim 1, wherein the asymmetric H-Bridge circuit with the plurality of cross-over switches is configured to achieve higher inductance and torque at lower speeds, and lower inductance and torque at higher speeds of operation.

3. The system (200) according to claim 1, wherein the plurality of cross-over switches used to connect asymmetric H-Bridge circuit to support series and parallel mode of operation for each phase of SRM, comprises two cross-over switches; and wherein the plurality of cross-over switches includes MOSFETs, SCR, Thyristor or Solid-state relays.

4. The system (200) according to claim 1, wherein the plurality of cross-over switches is used as bi-directional blocking devices and slow switching devices; and wherein the use of the plurality of cross-over switches as bi-directional blocking devices, is achieved by coupling the two cross-over switches in opposite directions.

5. The system (200) according to claim 1, wherein the plurality of switches in the asymmetric H-Bridge circuit includes MOSFETs, Power BJTs, IGBTs, SiC MOSFETs or GaN MOSFETs; and wherein the plurality of diodes is used in the asymmetric H-Bridge circuit to conduct current in one direction.

6. The system (200) according to claim 1, wherein the plurality of sub-windings connected through the plurality of cross-over switches in series mode, achieves higher effective inductance or torque at lower speeds; and wherein the effective inductance of the plurality of windings in series mode is twice the inductance of each of the plurality of sub-windings.

7. The system (200) according to claim 1, wherein the plurality of sub-windings connected through the plurality of cross-over switches in parallel mode, achieves lower effective inductance or torque at higher speeds; and wherein the effective inductance of the plurality of windings in parallel mode is half the inductance of each of the plurality of sub-windings.

8. The system (200) according to claim 1, wherein the asymmetric H-Bridge circuit with the plurality of cross-over switches is configured to connect the plurality of sub-windings in the series or parallel mode to achieve a wider range of inductance variation; and wherein the number of sub-windings is selected/chosen based on user requirement; and wherein the number of plurality of sub-windings, connected in series or parallel are increased, by using additional asymmetric H-Bridge circuits and the plurality of cross-switches.

9. A method (500) for operation of a switched reluctance motor (SRM) using switchover asymmetric H-Bridge circuit comprising the steps of:
a. configuring a plurality of windings on each phase of a SRM motor (502); and wherein the plurality of windings of each phase of the SRM comprises of a plurality of sub-windings or segments of equal turns;
b. controlling individually each of the plurality of sub-windings by an asymmetric H-Bridge circuit (504);
c. configuring the asymmetric H-Bridge circuit with a plurality of switches and a plurality of diodes (506);
d. connecting the asymmetric H-Bridge circuit, configuring each of the plurality of sub-windings through a plurality of cross-over switches (508); and wherein the connection between the asymmetric H-Bridge circuit, configuring plurality of sub-windings through the plurality of cross-over switches is established by connecting an end of one segment of the plurality of sub-windings and a start of the next segment of the plurality of sub-windings; and
e. performing both series and parallel mode of operation for each phase of the SRM to vary the inductance and torque or speed performance (510); and wherein the each of the series-parallel combination of the plurality of sub-windings with the plurality of cross-over switches is considered as a gear setting, and wherein the gear setting with the plurality of sub-windings in series is considered as a lower gear and the gear setting with the plurality of sub-windings in parallel is considered as a higher gear; and wherein the different gear settings are switched mutually to achieve the application demands of the SRM motor in an optimal manner.

10. The method (500) according to claim 9, wherein the required inductance or torque is achieved by:
a. measuring current torque and speed, and estimating a commanded torque;
b. evaluating and continuing to function normally, when the commanded torque and speed is within the capability of current inductance;
c. increasing inductance by determining whether the commanded torque level is above maximum torque at current speed level, and the current speed level is below a maximum speed limit at next higher gear; and
d. reducing inductance by determining whether the current speed level is above the maximum speed limit at the current torque level, and the commanded torque level is below the maximum torque level at next lower gear.

11. The method (500) according to claim 9, wherein the plurality of sub-windings connected through the plurality of cross-over switches in series mode, helps to achieve higher effective inductance or torque at lower speeds; and wherein the effective inductance of the plurality of windings in series mode is twice the inductance of each of the plurality of sub-windings.

12. The method (500) according to claim 9, wherein the plurality of sub-windings connected through the plurality of cross-over switches in parallel mode, helps to achieve lower effective inductance or torque at higher speeds; and wherein the effective inductance of the plurality of windings in parallel mode is half the inductance of each of the plurality of sub-windings.

13. The method (500) according to claim 9, wherein the asymmetric H-Bridge circuit with the plurality of cross-over switches is configured to connect the plurality of sub-windings in the series or parallel mode to achieve a wider range of inductance variation.

14. The method (500) according to claim 9, wherein the asymmetric H-Bridge circuit supporting series and parallel mode of operation for each phase of SRM, using the plurality of cross-over switches comprises two cross-over switches; and wherein the plurality of cross-over switches includes MOSFETs, SCR, Thyristor or Solid-state relays.

15. The method (500) according to claim 9, wherein the plurality of cross-over switches is used as bi-directional blocking devices and slow switching devices; and wherein the use of the plurality of cross-over switches as bi-directional blocking devices is achieved by using two cross-over switches in opposite directions.

16. The method (500) according to claim 9, wherein the plurality of switches in the asymmetric H-Bridge circuit includes MOSFETs, Power BJTs, IGBTs, SiC MOSFETs or GaN MOSFETs; and wherein the plurality of diodes is used in the asymmetric H-Bridge circuit to conduct current in one direction.
